(19) United States
(12) Patent Application Publication
(10) Pub. No.: US 2002/0071923 A1
(43) Pub. Date: Jun. 13, 2002

(54) NYLON CONTAINING LID FOR FOOD PACKAGING

(76) Inventors: VIRGINIA A. GARNER CULLISON, BONITA SPRINGS, FL (US); ALFIERI DEGRASSI, MILLSBORO, DE (US); DELROY G. BLISSETT, ORWIGSBURG, PA (US); SIMON J. PORTER, ALLENTOWN, PA (US)

Correspondence Address: ROGER H CRISS, HONEYWELL INTERNATIONAL INC, PO BOX 2245, 101 COLUMBIA ROAD, MORRISTOWN, NJ, 07962

(21) Appl. No.: 09/458,623

(22) Filed: Dec. 10, 1999

(51) Int. Cl. B29D 23/00

(52) U.S. Cl. 428/35.7; 53/471

(57) ABSTRACT

A food package comprising a two piece sealed package including metal free container and peelable lid portions which are readily separable from each other. The container is cup shaped and has a top opening and a substantially flat peripheral rim around the opening. The lid comprises a composite film having a shape which conforms to the shape of the opening and is attached to the rim. The film has a first outer polyamide or polyolefin layer attached to an inner layer of either an ethylene vinyl alcohol copolymer or a blend of a polyamide with an ethylene vinyl alcohol copolymer, which is attached to a second outer polyamide or polyolefin layer. The metal free packaged product allows the detection of metal contaminants inadvertently mixed with the food by scanning the product in the container to determine the presence of metal contaminants in the container.

### BACKGROUND OF THE INVENTION

1. Field of the Invention

The present invention pertains to food packages and more particularly to a two piece sealed package, including container and lid portions, which are readily separable from each other.

2. Description of the Related Art

It is well known in the art to provide plastic containers, for example, tubs, cups, jars and pails (hereinafter termed containers) which are useful for packaging, distributing and serving food items. Frequently, such containers are provided with a lid material, which seals its opening and yet is easily peeled for access to the food contents. Many lids are made of multiple layers of different plastics in order to achieve the desired barrier properties. Typically such are made of materials such as aluminum foil or are multi-layered laminates of a first plastic which serves as a water or solvent barrier, and a second plastic which serves as an oxygen or air barrier, or the laminate may be a metallized plastic i.e., metallized polyethylene terephthalate or metallized polypropylene. These barrier layers are usually held together with an adhesive or tie layer which facilitates the formation of the layers into a single sheet from which the lid is made. The typical moisture or solvent barrier plastic is a type of polyolefin such as polypropylene or polyethylene and the typical oxygen barrier plastic is a polyvinyl alcohol, an ethylene vinyl alcohol copolymer, a polyvinylidene chloride, a nylon, a polyacrylonitrile or a polyester. The tie layer is usually made of the polyolefin onto which are grafted some polar monomers, typically containing an acid or anhydride moiety, like polypropylene with maleic anhydride grafted thereto. The lids are usually made from multilayer sheets, which are embossed and then die cut into the desired shape or heat sealed to the base cup stock then die cut as the final process of the packaging operation.

Processes for producing these laminates are well known. If two thermoplastics are compatible, they can be combined by coextrusion to form a composite structure or laminated by melting the surfaces of the layers in contact with one another and by applying pressure. If the two thermoplastics are not compatible, they can be made into a laminate by placing an adhesive layer between the incompatible layers. The lid should be made of a material, which affords at least the same barrier properties as the container. It has been a problem in the art to provide a bond between the lid and the container which is adequate for moisture and oxygen barrier properties and yet is easily removable by the consumer for use. The bond between the lid and the container should preferably afford a strong barrier to oxygen and water, yet should be weak enough to be readily removed when the user seeks access to the contents of the container.

One way of solving this sealing problem is to use aluminum lids, which are heat-sealed to the container, wherein the lid is provided with an easily opened flap. For example, the aluminum lid may be melted or adhesively bonded to the container and provided with a tear-away tab. Alternatively, the aluminum foil lid can be precoated with a polymer that acts as an adhesive or which facilitates a heat-seal bond to the container. Such a bond must also be easily broken to allow access to the container contents.

A problem with aluminum foil and metallized polyolefin lids is that the packaged food cannot be scanned for unwanted metal shards which may inadvertently have mixed with the food. One solution is to employ a plastic lid, i.e. a plastic lid which may be melted to the lip of the container. Alternatively, the plastic film lid can be precoated with a polymer that acts as an adhesive or which facilitates a heat-seal bond to the container. Such a bond must also be easily broken to allow access to the container contents. Plastic lids would allow the packaged food to be scanned for unwanted metal shards. However, heretofore developed lids are either ineffective in providing a sufficient oxygen or moisture barrier, or are difficult to remove due to their stiffness (or lack thereof) or tendency to propagate tears when they are removed.

An important characteristic of plastic film laminates suitable for packaging materials is the ability to withstand the combination of heat and flexing to which it is often subjected during packaging processes and subsequent usage. However, many of the known laminates containing oxygen barrier layers are unsuitable for such procedures in which they are subjected to temperatures of from 80° C. to approximately 130° C. As a result of their low softening points, known barrier laminates are unable to maintain their structural integrity. Additionally, most plastic film laminates are not structurally stiff enough to be formed into lids by die-cutting and do not lend themselves to current packaging processes. U.S. Pat. Nos. 5,055,355 and 5,547,765, which are incorporated herein by reference, teach laminates of polyamides and ethylene vinyl alcohol copolymers which have excellent oxygen and moisture barrier properties. While these films have properties especially useful in packaging applications for food pouches for subsequent heating or cooking by the consumer, they have not been known heretofore as lidding materials.

Lidding stock has traditionally been heavy gauge aluminum foil, embossed aluminum foil, metallized PET or metallized polypropylene with a heat seal coating. None of these substrates can be effectively scanned for metal detection at the filling/packaging operation. The present invention provides a film which can be easily scanned by the food processor for metal detection. Additionally, the film does not tear propagate during the opening process. Tear propagation of lidding frequently and commonly occurs with aluminum foil, metallized PET and metallized polypropylene. Premature tear propagation is undesirable to consumer use and satisfaction. It can also render the foodstuff unsuitable for consumption if it occurs prior to sale or consumer use.

The lid of the invention can be easily scanned for metal detection as the final operation of the packaging process. This is an important step within the food manufacturing process as it insures both the processor and the consumer that the finished package and product is free of any foreign metal objects and safe for consumption. Finished packages of food products which are packed in aluminum foil, metallized polypropylene and metallized PET, common substrates for lidding, are not suitable for metal detection scanning.

The physical properties attained by this invention give the film which forms the lid a unique ability to be embossed, thus increasing overall stiffness of the sheet, i.e. producing a calendaring effect. This has not been accomplished heretofore in any other polymer-based film used in the food packaging industry. This is important to the denesting process of the die cut lids when in magazine form, and during the pick-up and application process of applying the lid to the container.

The lid of this invention may also provide pigmentation in a sandwich of polymers which produces opacity, and is easily cuttable by die cut, knifing, and or shearing action. The ease of cutting is unique, particularly when combined with the feature of resistance to tear propagation.

It is desirable that the lid and container entirely surround the contents in order to protect them and form a strong bond between them when the lid is sealed to the container. On the other hand, it is desirable that the lid be easily removable from the container by finger peeling without propagating tears. It is also desirable that the lid be made so that it may serve both as an oxygen barrier layer and a moisture barrier layer between the environment and the contents to reduce the risk of food spoilage. The invention provides a puncture resistant lid with excellent oxygen barrier, which is resistant to tear propagation, can be easily die cut and is receptive to being formed by coextrusion.

### SUMMARY OF THE INVENTION

The invention provides a peelable lid for a container, which container has a top opening and a substantially flat peripheral rim around the opening, which lid comprises a composite film having a shape which conforms to the shape of the opening when attached to the rim, the film having at least one first outer layer, each independently comprising a polyamide homopolymer, a polyamide copolymer, an olefin homopolymer or an olefin containing copolymer, which first outer layer is attached to one side of an inner layer of either an ethylene vinyl alcohol copolymer or a blend of a polyamide with an ethylene vinyl alcohol copolymer, which inner layer is attached on another side to at least one second outer layer independently comprising a polyamide homopolymer, a polyamide copolymer, an olefin homopolymer or a polyolefin copolymer; provided that at least one of the outer layers comprises a polyamide homopolymer or a polyamide copolymer.

The invention also provides a package comprising a container having a top opening and a substantially flat peripheral rim around the opening, and a peelable lid which conforms to the shape of the opening attached around the rim, which lid comprises a composite film having a shape which conforms to the shape of the opening when attached to the rim, the film having at least one first outer layer, each independently comprising a polyamide homopolymer, a polyamide copolymer, an olefin homopolymer or an olefin containing copolymer, which first outer layer is attached to one side of an inner layer of either an ethylene vinyl alcohol copolymer or a blend of a polyamide with an ethylene vinyl alcohol copolymer, which inner layer is attached on another side to at least one second outer layer independently comprising a polyamide homopolymer, a polyamide copolymer, an olefin homopolymer or a polyolefin copolymer; provided that at least one of the outer layers comprises a polyamide homopolymer or a polyamide copolymer.

The invention further provides a process of producing a packaged product free of metal contaminants which comprises:

a) providing a metal free container having enclosed side walls, a floor and an top opening defining a central cavity, which open top has a substantially flat peripheral rim,

b) filling the central cavity with a product;

c) sealing the open top by attaching a peelable lid around a circumference of the rim, which lid comprises a composite film having a shape which conforms to the shape of the opening when attached to the rim, the film having at least one first outer layer, each independently comprising a polyamide homopolymer, a polyamide copolymer, an olefin homopolymer or an olefin containing copolymer, which first outer layer is attached to one side of an inner layer of either an ethylene vinyl alcohol copolymer or a blend of a polyamide with an ethylene vinyl alcohol copolymer, which inner layer is attached on another side to at least one second outer layer independently comprising a polyamide homopolymer, a polyamide copolymer, an olefin homopolymer or a polyolefin copolymer; provided that at least one of the outer layers comprises a polyamide homopolymer or a polyamide copolymer; and

d) scanning the product in the container to determine the presence of metal contaminants in the container.

It is desirable to produce a lid for a food container as well as a lid and food container assembly which entirely surrounds and protects the contents and form a strong bond between them when the lid is sealed to the container. It is also desirable to provide a lid which can easily be removable from the container by finger peeling without propagating tears. It is also desirable that the lid serves both as an oxygen barrier layer and a moisture barrier layer between the environment and the contents to reduce the risk of food spoilage.

### DETAILED DESCRIPTION OF THE PREFERRED EMBODIMENT

The lid for the present invention comprises a film laminate having at least one first outer layer attached to one side of an inner layer of either an ethylene vinyl alcohol copolymer or a blend of a polyamide with an ethylene vinyl alcohol copolymer and at least one second outer layer attached to the other side of the inner layer. Each of the first and second outer layers independently comprises a polyamide homopolymer, a polyamide copolymer, an olefin homopolymer or an olefin containing copolymer. Importantly, at least one of the outer layers comprises a polyamide homopolymer or a polyamide copolymer. Thus, the film laminate has at least three layers, and may comprises four, five or more layers as desired by the skilled artisan. The laminates of the present invention can also include other polymeric film layers and adhesives thereon. The preferred film laminate is formed by coextrusion.

The polyamides may be aliphatic, aromatic or aliphatic/aromatic nylon homopolymer or copolymers. Polyamides suitable for use in the present invention include polyamides which are film forming. Preferred polyamides are long chain polymeric amides having recurring amide groups as part of the polymer backbone and preferably a relative formic acid viscosity (for nylon 6) of from about 40 to about 250 measured in 90 percent formic acid at a concentration of 9.2 weight percent.

Non-limiting examples of such polyamides are:

a) those prepared by the polymerization of lactams, preferably poly (ε-caprolactam) (nylon 6);

b) those prepared by the condensation of a diamine with a dibasic acid, preferably the condensation of hexamethylene diamine with adipic acid (nylon 6,6) and the condensation of hexamethylene diamine with sebacic acid (nylon 6,10);

c) those prepared by self-condensation of amino acids, preferably self-condensation of 11-aminoundecanoic acid (nylon 11); and

d) those based on polymerized vegetable oil acids, or random, block, or graft interpolymers consisting of two or more of these polyamides. Preferred polyamides are poly(ε-caprolactam), polyhexamethylene adipamide, and a copolymer of poly(ε-caprolactam) and polyhexamethylene adipamide.

Exemplary of such polyamides are poly(hexamethylene adipamide) (nylon 6,6), poly(hexamethylene sebacamide) (nylon 6, 10), poly(heptamethylene pimelamide) (nylon 7,7), poly(octamethylene suberamide) (nylon 8,8), poly(nonamethylene azelamide) (nylon 9,9), poly(decamethylene azelamide) (nylon 10,9), poly(4-aminobutyric acid) (nylon 4), poly(6-aminohexanoic acid) (nylon 6, also known as poly(caprolactam)), poly(7-aminoheptanoic acid) (nylon 7), poly(8-aminoocatanoic acid) (nylon 8), poly(9-aminononanoic acid) (nylon 9), poly(10-aminodecanoic acid) (nylon 10), poly(11-aminoundecanoic acid) (nylon 11), poly(12-aminododecanoic acid) (nylon 12) and the like. Blends of two or more aliphatic polyamides may also be employed. Copolymers formed from recurring units of the above referenced aliphatic polyamides can be used in the fabrication of the polyamide layers. By way of illustration and not limitation, such aliphatic polyamide copolymers include caprolactam/hexamethylene adipamide copolymer (nylon 6/6,6), hexamethylene adipamide/caprolactam copolymer (nylon 6,6/6), trimethylene adipamide/hexamethylene azelaiamide copolymer (nylon trimethyl 6,2/6,2), hexamethylene adipamide/hexamethylene-azelaiamide/caprolactam copolymer (nylon 6,6/6,9/6) and the like. Preferred aliphatic polyamides for use in the practice of this invention are poly(caprolactam) and poly(hexamethylene adipamide), with poly(caprolactam) being the most preferred. Polyamides used in the practice of this invention may be obtained from commercial sources or prepared in accordance with known preparatory techniques. For example, polycaprolactam can be obtained from Honeywell International Inc.

Exemplary of aliphatic/aromatic polyamides include poly (2,2,2-trimethyl hexamethylene terephthalamide), poly(m-xylylene adipamide) (MXD6), poly(p-xylylene adipamide), poly(hexamethylene terephthalamide), poly(dodecamethylene terephthalamide), and the like. Blends of two or more aliphatic/aromatic polyamides can also be used. The most preferred aliphatic/aromatic polyamide is poly(m-xylylene adipamide). Aliphatic/aromatic polyamides can be prepared by known preparative techniques or can be obtained from commercial sources.

The number average molecular weight of the polyamide may widely vary.

Usually, the aliphatic polyamide is of a “film-extrusion molecular weight”, meaning an average molecular weight that is sufficiently high to form a free standing film but sufficiently low to allow melt processing of the blend into a film. Such number average molecular weights are well known to those of skill in the film forming art and are usually at least about 5,000 as determined by the formic acid viscosity method. In this method (ASTM D-789), a solution of 11 grams of aliphatic polyamide in 100 ml of 90% formic acid at 25° C. is used. In the preferred embodiments of the invention, the number average molecular weight of the aliphatic polyamide ranges between about 5,000 to about 100,000, and in the particularly preferred embodiments it ranges between about 10,000 to about 60,000. Most preferred are those in which the number average molecular weight of the aliphatic polyamide is from about 20,000 to about 40,000. Also suitable for use herein are polyamide interpolymers comprised of a polyamide and one or more comonomers. Non-limiting examples of such comonomers include acrylic or methacrylic acid and/or their derivatives, such as acrylonitrile, acrylamide, methyl, ethyl, propyl, butyl, 2-ethylhexyl, hexyl and tridecylesters of acrylic or methacrylic acid, vinyl esters such as vinyl acetate and vinyl propionate, vinyl aromatic compounds such as styrene, alpha-methyl styrene, and vinyl toluenes and vinyl ethers such as vinyl isobutyl ether.

It is further noted that the aforementioned polyamides containing various terminal functionality are also suitable for use in the present invention. Preferred are polycaprolactams (nylon 6) containing a carboxyl group attached to one end and an acetamide group attached to the other end of the polymer chain, an amino group attached to both ends of the polymer chain and a carboxyl group attached to one end and an amino group attached to the other end of the polymer chain. Particularly preferred is a polycaprolactam having a carboxyl group attached to one end and an amino group attached to the other end of the polymer chain.

The polyolefins used herein include polymers of alpha-olefin monomers having from about 2 to about 6 carbon atoms and includes homopolymers, copolymers (including graft copolymers), and terpolymers of alpha-olefins. Illustrative homopolymer examples include ultra low density (ULDPE), low density (LDPE), linear low density (LLDPE), medium density (MDPE), or high density polyethylene (HDPE); polypropylene; polybutylene; polybutene-1; poly-3-methylbutene-1; poly-pentene-1; poly-4-methylpentene-1; polyisobutylene; and polyhexene.

Polyolefins such as polyethylenes are commonly differentiated based on the density which results from their numbers of chain branches per 1,000 carbon atoms in the polyethylene main chain in the molecular structure. Branches typically are C₃-C₈ olefins, and which are preferably butene, hexene or octene. For example, HDPE has very low numbers of short chain branches (less than 20 per 1,000 carbon atoms), resulting in a relatively high density, i.e. density ranges from about 0.94 gm/cc to about 0.97 gm/cc. LLDPE has more short chain branches, in the range of 20 to 60 per 1,000 carbon atoms with a density of about 0.91 to about 0.93 gm/cc. LDPE with a density of about 0.91 to about 0.93 gm/cc has long chain branches (20-40 per 1,000 carbon atoms) instead of short chain branches in LLDPE and HDPE. ULDPE has a higher concentration of short chain branches than LLDPE and HDPE, i.e. in the range of about 80 to about 250 per 1,000 carbon atoms and has a density of from about 0.88 to about 0.91 gm/cc. Illustrative copolymer and terpolymers include copolymers and terpolymers of alpha-olefins with other olefins such as ethylene-propylene copolymers; ethylene-butene copolymers; ethylenepentene copolymers; ethylene-hexene copolymers; and ethylene-propylene5 diene copolymers (EPDM). The term polyolefin as used herein also includes acrylonitrilebutadiene-styrene (ABS) polymers, copolymers with vinyl acetate, acrylates and methacrylates and the like. Preferred polyolefins are those prepared from alpha-olefins, most preferably ethylene polymers, copolymers, and terpolymers. The above polyolefins may be obtained by any known process. The polyolefin may have a weight average molecular weight of about 1,000 to about 1,000,000, and preferably about 10,000 to about 500,000. Preferred polyolefins are polyethylene, polypropylene, polybutylene and copolymers, and blends thereof. The most preferred polyolefins are polyethylene and polypropylene.

Each layer of the multilayer film structure can contain additives which are conventionally used in such films. Examples of such additives are pigments, dyes, slip additives, fillers, nucleating agents, plasticizers, lubricants, antiblocking agents, stabilizers and inhibitors of oxidation, thermal stabilizers and ultraviolet light stabilizers. Such may be present in an amount of about 10% or less based on the weight of the layer. Preferably at least one of the inner and/or outer layers contains titanium dioxide.

The inner layer can either be an ethylene-vinyl alcohol copolymer(“EVOH”) or a blend of a polyamide and an ethylene-vinyl alcohol copolymer. Copolymers of ethylene and vinyl alcohol suitable for use in the present invention can be prepared by the methods disclosed in U.S. Pat. Nos. 3,510,464; 3,560,461; 3,847,845; and 3,585,177.

The ethylene vinyl alcohol copolymer (EVOH) which is used fore the inner layer can be hydrolyzed ethylene vinyl acetate copolymer. The degree of hydrolysis can range from 85 to 99.5%. The ethylene vinyl alcohol copolymer preferably contains from 15 to 65 mol percent ethylene and more preferably 25 to 48 mol percent ethylene. Copolymers of lower than 15 mol percent ethylene tend to be difficult to extrude while those above 65 mol percent ethylene have reduced oxygen barrier performance.

When the inner layer of the laminate contains or includes EVOH and a polyamide, the EVOH component in the blend has an ethylene content of from about 27 mole percent to about 48 mole percent, preferably from about 27 mole percent to about 44 mole percent, and most preferably from about 32 mole percent to about 38 mole percent. The EVOH component further has a density ranging from about 1.12 g/cm³ to about 1.20 g/cm³, and a melting temperature ranging from about 142° C. to about 191° C. EVOH can be prepared by known preparative techniques or can be obtained from commercial sources. Suitable copolymers are described in U.S. Pat. Nos. 4,252,169 and 3,595,740. Blends may comprise from about 50% to 95%, preferably 65% to 85% of the polyamide and from about 5% to 50%, preferably 15% to 35% of EVOH. As used herein, all percentages are by weight. Blends are formed by mechanically blending the polyamide and EVOH in a drum tumbler at room temperature for about 30 minutes. Alternatively, blends may be formed by melt blending technologies or any other mixing process that forms an intimate physical mix of the polymers in question. This also includes mixing resulting from blending extrusion and final pelletization of the extruded blend. Most preferably, about 70% to 80% weight of the polyamide is mechanically blended with about 20% to 30% weight of EVOH.

In addition to the above described inner and outer layers, the films may include one or more optional outer layers. Illustrative of such additional optional layers are polymeric layers formed of homopolymers and copolymers formed from polyvinyl alcohol, ethylene/vinyl alcohol copolymer and blends thereof. Additional layers may also include adhesive tie layers to tie various layers together. Non-limiting examples of other optional polymeric layers and adhesive or tie layers which can be used in the film laminate of the present invention are disclosed in U.S. Pat. Nos. 5,055,355; 3,510,464; 3,560,461; 3,847,845; 5,032,656; 3,585,177; 3,595,740; 4,284,674; 4,058,647; and 4,254,169.

The film of this invention is not limited to the three layers described above. The film may also include any number of additional polyamide, polyolefin or EVOH layers on the above described structure. The film of this invention can be formed by any conventional technique for forming films, including extrusion lamination and coextrusion. In the most preferred method, the film is formed by coextrusion. For example, the material for the individual layers, as well as any optional layers, are fed into infeed hoppers of the extruders of like number, each extruder handling the material for one or more of the layers. The melted and plasticated streams from the individual extruders are fed into a single manifold co-extrusion die. While in the die, the layers are juxtaposed and combined, then emerge from the die as a single multiple layer film of polymeric material. After exiting the die, the film is cast onto a first controlled temperature casting roll, passes around the first roll, and then onto a second controlled temperature roll, which is normally cooler than the first roll. The controlled temperature rolls largely control the rate of cooling of the film after it exits the die. In another method, the film forming apparatus may be one which is referred to in the art as a “blown film” apparatus and includes a multi-manifold circular die head for bubble blown film through which the plasticized film composition is forced and formed into a film “bubble which may ultimately be collapsed and formed into a film. Processes of coextrusion to form film and sheet laminates are generally known. See for example in “Modern Plastics Encyclopedia”, Vol. 56, No. 10A, pp. 131-132, McGraw Hill, October 1979. Alternatively the individual layers may first be formed into sheets and then laminated together under heat and pressure with or without intermediate adhesive layers. The films of this invention may be of any thickness desired and include those which have thicknesses typically less than about 20 mils (500 μm). Preferably, the films have a thickness of from about 0.1 mil (3 μm) to about 10 mils (250 μm); more preferably the films have a thickness of from about 2 mils (48 μm) to about 5 mils (130 μm). While such thicknesses are preferred as providing a readily flexible film, it is to be understood that other film thicknesses may be produced to satisfy a particular need and yet fall within the scope of the present invention.

The films of this invention may optionally be stretched or oriented in any direction, if so desired, using methods known to those of skill in the art. In such a stretching operation, the film may be stretched in either the direction coincident with the direction of movement of the film being withdrawn from the casting roll, also referred to in the an as the “machine direction”, i.e. the direction which is perpendicular to the machine direction, and referred to in the art as the “transverse direction” where the resulting film is “uniaxially” oriented; or the machine direction as well as in the transverse direction, where the resulting film is “biaxially” oriented. Typically for use in the present invention, the oriented film formed from the composition of the invention are preferably produced at draw ratios of from about 1.5:1 to about 10:1, and preferably at a draw ratio of from about 1.5:1 to about 4:1. The term “draw ratio” as used herein indicates the increase of dimension in the direction of the draw. Therefore, a film having a draw ratio of 2:1 has its length doubled during the drawing process. Generally, the film is drawn by passing it over a series of preheating and heating rolls. The heated film moves through a set of nip rolls downstream at a faster rate than the film entering the nip rolls at an upstream location. The change of rate is compensated for by stretching in the film.

Typical process and range of conditions for monoaxially oriented polyamide films are disclosed, for example, in U.S. Pat. No. 4,362,385. The film laminate of the present invention can be biaxially oriented using blown tube apparatus, or a tenter frame apparatus, and can either be sequentially or simultaneously oriented biaxially. The film laminate of the present invention can also be embossed after orientation.

One noteworthy characteristic of the films of this invention is that they exhibit excellent gas barrier properties, particularly oxygen barrier properties, at 90% relative humidity (RH). Oxygen barrier resistance may be measured using the procedure of ASTM D-3985. In general, using the aforesaid method, the films of this invention have an oxygen transmission rate (O₂ TR) at 90% relative humidity equal to or less than about 0.5 cm³/100 in² (645 cm²)/24 hrs/Atm at 23° C. Preferably the lid film has a oxygen transmission rate less than or equal to that of the container stock. The superior oxygen barrier properties of the lidding of this invention makes them especially useful in food lid applications.

In order to produce a food container lid, a sheet of the film is cut, preferably die cut to the desired size and shape. Preferably the lid has a pull tab in order to ease finger peeling removal. Preferably the film is opaque and is embossed. The lid should have that amount of thickness and stiffness to allow easy peel off of the container to which it is attached without tearing. Preferably the lid film has a moisture vapor transmission rate equivalent to either the container stock or the shelf life requirements of the food stuff. This rate typically ranges from about 0.05 cc/100 in.² (645 cm²)/24 hrs at 70° F. (21° C.), 50% relative humidity to about 20 cc/100 in.² (645 cm²)/24 hrs. at 70° F. (21° C.), 50% relative humidity or more preferably from about 1 cc to about 16 cc/100 in.² (645 cm²)/24 hrs at 70° F. (21° C.), 50% relative humidity. Preferably at least one of the outer layers has a printable surface on a surface opposite to the inner layer of ethylene vinyl alcohol copolymer.

The invention further comprises a package comprising a metal free cup shaped container having enclosed side walls, a floor and an top opening defining a central cavity, which open top has a substantially flat peripheral rim, and the above described peelable lid which conforms to the shape of the opening attached around the rim. The container may comprise a metal free material such as cardboard, paperboard, boardstock, a plastic and combinations thereof. Preferred plastics include any one of several thermosetting or thermoplastic resins any of which are capable of sealing to the lidding material. Examples of materials include acrylonitrile, an acrylic polymer, polyethylene terephthalate (PET), polyvinyl chloride, polycarbonate, copolymers of “PET”, polystyrene and polypropylene.

The lid can be heat sealed such as by means of a heat sealable material placed around a peripheral edge of the lid for attaching to the rim of a container. The lid can be adhered to the rim of the container by means of an adhesive, such as a thermoplastic hot melt adhesive, for example a layer of a petroleum wax-ethylene vinyl acetate or any suitable polyolefin copolymer composition which serves as an heat activated adhesive or sealant material when subsequently subjected to heat and pressure by the packer. Typically, after the container has been filled, the lid is pressed against the container rim as heat and pressure are applied to provide a peelable seal therebetween.

A significant advantage of the package of the present invention is that the complete package is less expensive to produce than conventional prior art packages, and it still provides excellent sealing equalities for a packaged product to extend its shelf life. Also, it is adapted to facilitate easy opening by the consumer, who can quickly peel the lid from the container to open the package.

In use, the metal free cup shaped container as described above is filled through its central cavity with a product such as a food through the open top. The top is then closed by sealing the open top by attaching the peelable lid around the rim. Thereafter, the product and closed container combination may be scanned by suitable equipment to determine the presence of metal contaminants mixed with the product in the container. While it is contemplated that the container will hold a food product, it could just as well hold a pharmaceutical composition, an electronic component or a medical device.

The following non-limiting examples serve to illustrate the invention.

### EXAMPLE 1

A co-extruded laminate was made from poly(ε-caprolactam) (nylon 6) and ethylene vinyl alcohol. The poly(ε-caprolactam) polymer used had a relative formic acid viscosity of 73 measured in 90% formic acid and a 9.2% concentration by weight. The ethylene vinyl alcohol was Grade LC-F produced by Kuraray of Japan. The ethylene vinyl alcohol was in pellet form and had a melt index of 1.5 g per 10 minutes as measured on the ASTM Test No. 1238 at a load of 2160 g at 190° C. The ethylene vinyl alcohol copolymer contains 67 mol percent vinyl alcohol and had a glass transition temperature of 69° C. The ethylene vinyl alcohol copolymer (EVOH) and the poly(ε-caprolactam) were co-extruded to form a (nylon 6/EVOH/nylon 6) co-extruded film laminate. The poly-(ε-caprolactam) was extruded through a 3.5 inch (8.89 cm) diameter Davis Standard Extruder having a temperature profile of Zone 1—510° F. (266° C.), Zone 2—511° F. (266° C.), Zone 3—512° F. (267° C.), Zone 4—492° F. (256° C.), Zone 5—488° F. (253° C.) and adapter Zone 1—490° F. (254° C.),. The extruder operated with a screw speed of 44 rpm, a motor drive 42 amps, a barrel pressure of 900 psig (6.29×10³ kPa), the melt temperature of the nylon at 501° F. (260° C.), and an extruder output of 60 pounds (27.27 kg) per hour.

The ethylene vinyl alcohol copolymer was extruded through a 2 inch (5.08 cm) diameter Wellex Extruder. The extruder had a temperature profile which included Zone 1—430° F. (221° C.), Zone 2—450° F. (232° C.), Zone 3—470° F. (243° C.), Zone 4—470° F. (243° C.), and an adapter Zone 1—490° F. (254° C.). The operating conditions of the extruder included a screw speed of 30 rpm, a motor drive amperage of 8 amps, a melt temperature of 461° F. (238° C.), and an extruder output of 16 pounds (7.26 kg) per hour.

The extrudate from the extruders was put through a feed block coextrusion adapter manufactured by the Johnson Plastic Corporation and operating at an adapter temperature of Zone 1—490° F. (254° C.), and Zone 2—480° F. (249° C.). The flat cast die temperatures were operated at 490° F. (254° C.). The coextruded film was then cast on a roll at 180° F. (82° C.), followed by a cooling roll at 145° F. (63° C.), and an additional roll at 200° F. (93° C.). The total extrusion output was 76 pounds (34.5 kg) per hour.

The film had a gauge of 2.5 mils (63.5 microns) and was not oriented.

The film is was die cut to a circular shape (typically) having a pull tab. The outer perimeter of the circular portion was applied with layer of a petroleum wax-ethylene vinyl acetate copolymer thermoplastic hot melt adhesive (may also be a coextrusion of nylon/EVOH/heat seal polyolefin). The adhesive on the lid was applied to the flat rim of a thermoformable plastic cup, subjected to heat and pressure, and cooled to provide a peelable seal.

### EXAMPLE 2

A three layer co-extruded structure was made from two nylon 6 layers, sandwiching an interior layer formed of a blend of 75 weight percent poly(iminomethylene-1,3-phenylene iminoadipoylene) (MXD6) and 25 weight percent of EVOH. The MXD6 and EVOH were previously preblended in a drum tumbler at room temperature for approximately 30 minutes.

The nylon 6, which was produced by Honeywell International Inc., had a relative formic acid viscosity of 73 and a melt index of 0.7 g per 10 minutes at a load of 325 kg. at 275° C. (condition K). The MXD6, which was produced by Mitsubishi Gas Chemical Company of Japan, was in pellet form and had a melt index of 4.0 g per 10 minutes as measured per the ASTM Test No. D1238 at a load of 325 kg at 275° C. (condition K). The EVOH, which was produced by Nippon Gohsei Company, Ltd. of Japan under the tradename Soarnol DC 3203, had an ethylene content of 32 molecular percent, a density of 1.19 g/cm³ and a melting temperature of 183° C. (U.S. Pat. No. 5,547,765).

The MXD6/EVOH blend layer and the two layers of nylon 6 were co-extruded to form a three layer co-extruded film such that the blend layer was in between the two layers of nylon 6. The nylon 6 layers were extruded through a 31/2 inch (88.9 mm) diameter Davis Standard Extruder having a temperature profile of Zone 1—510° F. (266° C.), Zone 2—510° F. (266° C.), Zone 3—510° F. (266° C.), Zone 4—495° F. (257° C.), Zone 5—495° F. (257° C.), and adapter Zone 1—490° F. (254° C.). The extruder operated with a screw speed of 25 to 30 rpm, a motor drive amperage of 25 amps, a barrel pressure of 1000 psig (6.99×10³ kPa), a melt temperature of the nylon at 490° F. (254° C.), and an extruder output of 120 pounds per hour (54.43 kg/hr).

The MXD6/EVOH blend layer was extruded through a 2 inch (50.8 mm) diameter Wellex extruder. The extruder had a temperature profile which included Zone 1—485° F. (252° C.), Zone 2—480° F. (249° C.), and Zone 3—490° F. (254° C.) and adapter Zone 1—485° F. (252° C.). The operating conditions of the extruder included a screw speed of 100 rpm, a motor drive amperage of 10 to 15 amps, a melt temperature of 513° F. (267° C.), and an extruder output of 60 pounds per hour (27.22 kg/hr).

The extrudate from the two extruders was fed through a feed block coextrusion adapter manufactured by the Johnson Plastic Corporation and operating at an adapter temperature of Zone 1—about 500° F. (260° C.) to 525° F. (274° C.), and Zone 2—about 500° F. (260° C.) to 525° F. (274° C.). The flat cast die temperatures were operated at about 500° F. (260° C.). The coextruded film was then cast on a roll at a temperature of about 190° F. (88° C.) and a rotation speed of 40 feet/min (12.19 m/min), followed by a preheat roll at a temperature of about 220° F. (104° C.) and a rotation speed of 42 feet/min (12.8 m/min). The total extrusion output was 180 pounds per hour (81.65 kg/hr).

The film had an average gauge of 1.082 mils (27.5 microns) and was not oriented.

The film is die cut to a circular shape having a pull tab. A polypropylene cup is filled with yogurt and the outer perimeter of the circular portion of the lid is applied with layer of a petroleum wax-ethylene vinyl acetate copolymer thermoplastic hot melt adhesive. The adhesive on the lid is applied to the flat rim of a thermoformable plastic cup, subjected to heat and pressure, and cooled to provide a peelable seal. The thusly produced product is scanned in metal detecting equipment and found to be free of metal shards.

It can be seen that the present invention provides excellent lidding material for food containers. While the present invention has been particularly shown and described with reference to preferred embodiments, it will be readily appreciated by those of ordinary skill in the art that various changes and modifications may be made without departing from the spirit and scope of the invention. It is intended that the claims be to interpreted to cover the disclosed embodiment, those alternatives which have been discussed above and all equivalents thereto.

What is claimed is:

1. A peelable lid for a container, which container has a top opening and a substantially flat peripheral rim around the opening, which lid comprises a composite film having a shape which conforms to the shape of the opening when attached to the rim, the film having at least one first outer layer, each independently comprising a polyamide homopolymer, a polyamide copolymer, an olefin homopolymer or an olefin containing copolymer, which first outer layer is attached to one side of an inner layer of either an ethylene vinyl alcohol copolymer or a blend of a polyamide with an ethylene vinyl alcohol copolymer, which inner layer is attached on another side to at least one second outer layer independently comprising a polyamide homopolymer, a polyamide copolymer, an olefin homopolymer or a polyolefin copolymer; provided that at least one of the outer layers comprises a polyamide homopolymer or a polyamide copolymer.

2. The lid of claim 1 wherein at least one of the layers comprises titanium dioxide.

3. The lid of claim 1 wherein the ethylene vinyl alcohol copolymer has from about 15 to about 65 mol percent ethylene and a degree of hydrolysis of from about 85 to about 99.5%.

4. The lid of claim 1 wherein each polyamide layer independently comprises poly(caprolactam), poly(hexamethylene adipamide) or a combination thereof.

5. The lid of claim 1 wherein at least one outer layer comprises polypropylene.

6. The lid of claim 1 wherein the film is unoriented.

7. The lid of claim 1 wherein the film is drawn to a draw ratio of from about 1.5:1 to about 10:1 in at least one direction.

8. The lid of claim 1 wherein the film is a coextruded film.

9. The lid of claim 1 comprising a pull tab.

10. The lid of claim 1 wherein a surface of the film is embossed.

11. The lid of claim 1 wherein the film has a thickness of from about 3 μm to about 500 μm.

12. The lid of claim 1 wherein said film is substantially opaque.

13. The lid of claim 1 wherein the film has an oxygen transmission rate at 90% relative humidity of about 0.5 cm³/100 in²/24 hrs/Atm or less at 23° C.

14. The lid of claim 1 wherein the film has a moisture vapor transmission rate of from about 0.05 cc to about 20 cc/100 in.²/24 hrs. at 70° F. and 50% relative humidity.

15. The lid of claim 1 further comprising a heat sealable material around a peripheral edge of the lid for attaching to the rim of a container.

16. The lid of claim 1 further comprising an adhesive around a peripheral edge of the lid for attaching to the rim of a container.

17. The lid of claim 1 wherein at least one of the outer layers has a printable surface on a surface opposite to the inner layer of ethylene vinyl alcohol copolymer.

18. A package comprising a container having a top opening and a substantially flat peripheral rim around the opening, and a peelable lid which conforms to the shape of the opening attached around the rim, which lid comprises a composite film having a shape which conforms to the shape of the opening when attached to the rim, the film having at least one first outer layer, each independently comprising a polyamide homopolymer, a polyamide copolymer, an olefin homopolymer or an olefin containing copolymer, which first outer layer is attached to one side of an inner layer of either an ethylene vinyl alcohol copolymer or a blend of a polyamide with an ethylene vinyl alcohol copolymer, which inner layer is attached on another side to at least one second outer layer independently comprising a polyamide homopolymer, a polyamide copolymer, an olefin homopolymer or a polyolefin copolymer; provided that at least one of the outer layers comprises a polyamide homopolymer or a polyamide copolymer.

19. The package of claim 18 wherein the container comprises a material selected from the group consisting of cardboard, paperboard, boardstock, a plastic and combinations thereof.

20. The package of claim 18 wherein the ethylene vinyl alcohol copolymer has from about 15 to about 65 mol percent ethylene and a degree of hydrolysis of from about 85 to about 99.5%.

21. The package of claim 18 wherein each polyamide layer independently comprises poly(caprolactam), poly(hexamethylene adipamide) or a combination thereof.

22. The package of claim 18 wherein at least one of the layers comprises titanium dioxide.

23. The package of claim 18 wherein at least one outer layer comprises polypropylene.

24. The package of claim 18 wherein the film is unoriented.

25. The package of claim 18 wherein the film is produced by coextruding the inner and outer layers.

26. The package of claim 18 wherein a surface of the film is embossed.

27. The package of claim 18 wherein the lid is attached to the rim of the container by means of a heat sealable material around a peripheral edge of the lid.

28. The package of claim 18 wherein the lid is attached to the rim of the container by means of an adhesive around a peripheral edge of the lid.

29. The package of claim 18 wherein the product is a food.

30. The package of claim 18 wherein the product is a pharmaceutical composition, an electronic component or a medical device.

31. A process of producing a packaged product free of metal contaminants which comprises:
a) providing a metal free container having enclosed side walls, a floor and an top opening defining a central cavity, which open top has a substantially flat peripheral rim,
b) filling the central cavity with a product;
c) sealing the open top by attaching a peelable lid around a circumference of the rim, which lid comprises a composite film having a shape which conforms to the shape of the opening when attached to the rim, the film having at least one first outer layer, each independently comprising a polyamide homopolymer, a polyamide copolymer, an olefin homopolymer or an olefin containing copolymer, which first outer layer is attached to one side of an inner layer of either an ethylene vinyl alcohol copolymer or a blend of a polyamide with an ethylene vinyl alcohol copolymer, which inner layer is attached on another side to at least one second outer layer independently comprising a polyamide homopolymer, a polyamide copolymer, an olefin homopolymer or a polyolefin copolymer; provided that at least one of the outer layers comprises a polyamide homopolymer or a polyamide copolymer; and
d) scanning the product in the container to determine the presence of metal contaminants in the container.

32. The process of claim 31 wherein the product is a food.
